(19) United States
(12) Patent Application Publication
(10) Pub. No.: US 2010/0291517 A1
(43) Pub. Date: Nov. 18, 2010

(54) MATH GAME FOR TEACHING MULTIPLICATION

(76) Inventor: Anne Sims, Las Vegas, NV (US)

Correspondence Address: WEISS & MOY PC, 4204 NORTH BROWN AVENUE, SCOTTSDALE, AZ, 85251, US

(21) Appl. No.: 12/465,833

(22) Filed: May 14, 2009

(51) Int. Cl. G09B 1/00; A63F 9/00

(52) U.S. Cl. 434/209; 273/459

(57) ABSTRACT

A math game for teaching multiplication tables is disclosed. The math game will teach multiplication of the numbers 6-10 and will also help to provide a review of the multiplication of numbers 0-4. The math game uses visual implements to assist with the learning process.

### FIELD OF THE INVENTION

This invention relates generally to mathematics and, more specifically, to a math game for teaching multiplication.

### BACKGROUND OF THE INVENTION

Children usually begin learning multiplication tables during the third grade. Multiplication of numbers 1-5 are fairly easy to learn because they involve small numbers that may be counted on one's fingers. The multiplication of larger numbers 6-10 typically prove to be much harder to learn and to remember.

The present invention provides a simple math game that will help to teach multiplication of the numbers 6-10 and will also help to provide a review of multiplication of the numbers 0-4. The math game uses visual implements to assist with the learning process.

### SUMMARY OF THE INVENTION

In accordance with one embodiment of the present invention, a math game is disclosed. The math game comprises the steps of: providing two sets of finger coverings, each set comprising five finger coverings indicating the numbers 6, 7, 8, 9, and 10; placing a first set of finger coverings in numerical order on a first hand of a user and placing a second set of finger coverings in numerical order on a second hand of the user; touching a finger covering of the first hand to a finger covering of the second hand; determining a points total by assigning a predetermined amount of points for each touching finger covering and for each finger covering located one of above and below the touching finger coverings; determining a first sum by adding a number of finger coverings on the first hand located on an opposite side of the touching finger coverings; determining a second sum by adding a number of finger coverings on the second hand located on an opposite side of the touching finger coverings; determining a first product by multiplying the first sum with the second sum; and determining a final product of the numbers appearing on the touching finger coverings by adding the first product to the points total.

In accordance with another embodiment of the present invention, a math game is disclosed. The math game comprises the steps of providing two sets of finger coverings, each set comprising five finger coverings individually numbered 6, 7, 8, 9, and 10; placing a first set of finger coverings in ascending order on a first hand of a user and placing a second set of finger coverings in ascending order on a second hand of the user; selecting a first factor to multiply with a second factor wherein the first factor and second factor are each one of 6, 7, 8, 9, and 10; determining a points total by assigning a predetermined amount of points to each of the touching finger coverings and to each of the finger coverings located above the touching finger coverings; determining a first sum by adding a number of finger coverings on the first hand that are located below the touching finger coverings; determining a second sum by adding a number of finger coverings on the second hand that are located below the touching finger coverings; determining a first product by multiplying the first sum with the second sum; and determining a final product of the first factor and the second factor by adding the first product to the points total.

In accordance with another embodiment of the present invention, a math game is disclosed. The math game comprises the steps of providing two sets of finger coverings, each set comprising five finger coverings individually numbered 6, 7, 8, 9, and 10; placing a first set of finger coverings in descending order on a first hand of a user and placing a second set of finger coverings in descending order on a second hand of the user; selecting a first factor to multiply with a second factor wherein the first factor and second factor are each one of 6, 7, 8, 9, and 10; determining a points total by assigning a predetermined amount of points to each of the touching finger coverings and to each of the finger coverings located below the touching finger coverings; determining a first sum by adding a number of finger coverings on the first hand that are located above the touching finger coverings; determining a second sum by adding a number of finger coverings on the second hand that are located above the touching finger coverings; determining a first product by multiplying the first sum with the second sum; and determining a final product of the first factor and the second factor by adding the first product to the points total.

### BRIEF DESCRIPTION OF THE DRAWINGS

FIG. 1 is a side view of a pair of hands, wherein the person is playing the math game of the present invention. In order to multiply 8×7, the person is shown touching a finger covering bearing a number 8 to a finger covering bearing a number 7.

FIG. 2 is a perspective view of one of the finger coverings used in FIG. 1.

FIG. 3 is a perspective view of another embodiment of a finger covering.

FIG. 4 is a side view of a pair of hands, shown using another embodiment of the finger coverings. In order to multiply 9×8, the person is shown touching a finger covering bearing a number 9 to a finger covering bearing a number 8.

FIG. 5 is a perspective view of one of the finger coverings used in FIG. 4.

FIG. 6 is a perspective view of another embodiment of a finger covering.

FIG. 7 is a perspective view of a hand, shown using another embodiment of the finger coverings.

FIG. 8 is a perspective view of one of the finger coverings used in FIG. 7.

FIG. 9 is a flowchart depicting the steps of the math game for teaching multiplication.

### DETAILED DESCRIPTION OF THE PREFERRED EMBODIMENTS

The novel features believed characteristic of the invention are set forth in the appended claims. The invention will best be understood by reference to the following detailed description of illustrated embodiments when read in conjunction with the accompanying drawings, wherein like reference numerals and symbols represent like elements.

FIGS. 1-9 together show a math game for teaching multiplication. In order to play the game, one may use two sets of finger coverings 10.

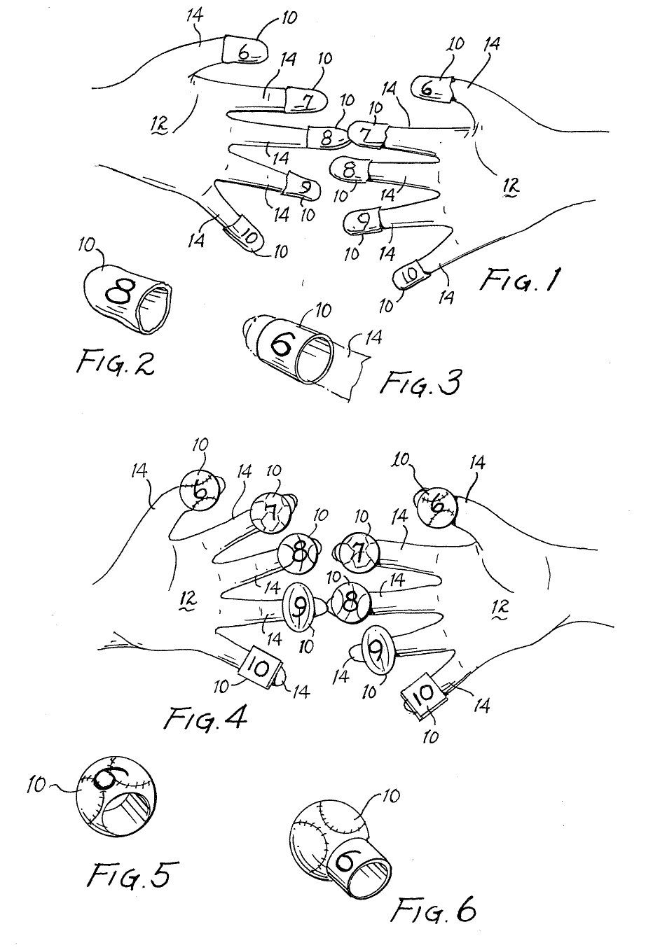

FIG. 1 shows two hands 12, wherein each hand 12 is fitted with a set of finger coverings 10. As shown in FIGS. 1-3, the finger coverings 10 may be made of, leather, fabric, or yarn and the numbers may be sewn, inked, written, embroidered, printed, pinned, adhered, or otherwise coupled to the finger coverings 10 so that the numbers are visible to the user. The finger coverings 10 may be closed at one end (see FIG. 2) or may be open at both ends (see FIG. 3) so that a user's finger 14 may pass all the way through the finger covering 10.

As shown in the figures, each finger 14 bears one finger covering 10. The finger coverings 10 will have the numbers 6, 7, 8, 9, and 10 on them and are placed on the user's fingers 14 in numerical order. FIG. 1 shows the Number 6 finger covering 10 on the user's thumb; the Number 7 finger covering 10 on the user's index finger; the Number 8 finger covering 10 on the user's middle finger; the Number 9 finger covering 10 on the user's ring finger; and the Number 10 finger covering 10 on the user's pinky.

FIG. 4 shows another set of hands 12 fitted with another set of finger coverings 10. As shown in FIGS. 4-6, the finger coverings 10 may be made of plastic, rubber, metal, or some other solid or flexible material. The numbers may be printed, etched, pressed, painted, adhered, or otherwise imprinted on the finger coverings 10 so that the numbers are visible to the user. The finger coverings 10 may be closed at one end (see FIG. 6) or may be open at both ends (see FIG. 5) so that a user's finger 14 may pass all the way through the finger covering 10.

As shown in the figures, the finger coverings 10 may have certain themes for males and females. For example, FIG. 4 shows mostly a sports theme wherein the finger coverings 10 in a set may be different types of sports balls; e.g. baseball, soccer ball, basketball, football, etc. It should be clearly understood that substantial benefit may be derived from themes other than sports, such as cars, animals, colors, jewels, flowers, etc. It should be further understood that substantial benefit may still be derived from finger coverings 10 that do not have a theme.

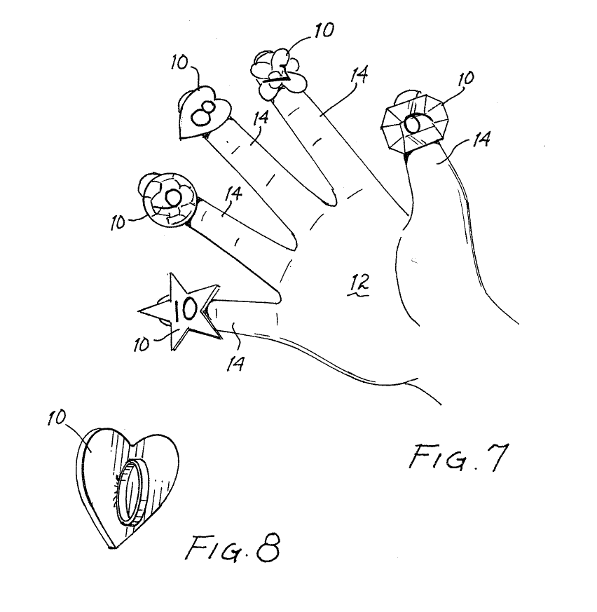

FIG. 7 shows another hand 12 fitted with another set of finger coverings 10. The finger coverings 10 of this set are multiple types of shapes: a jewel, a flower, a heart, a ball, and a star. It should be clearly understood that substantial benefit may be derived from the finger coverings 10 being any shape as long as they bear the numbers 6, 7, 8, 9, and 10 in numerical order and the numbers are visible to the user. It should also be clearly understood that the finger coverings 10 may be stickers. As shown in FIG. 8, the finger coverings 10 may have a ring portion that is slid over the fingers 14.

### Statement of Operation

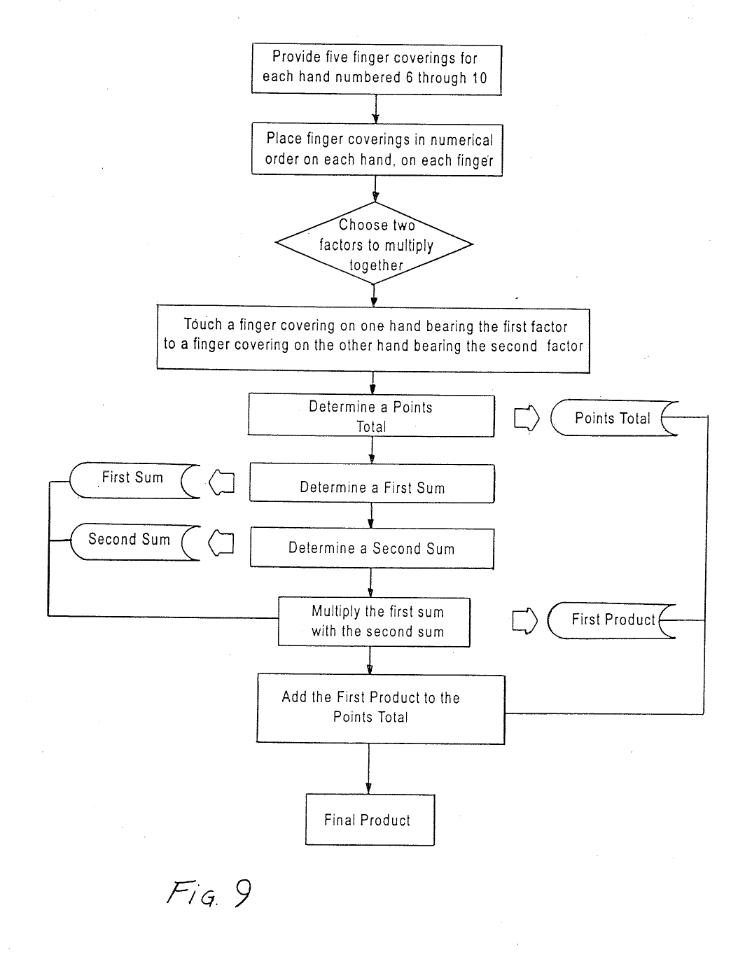

FIG. 9 is a flowchart showing how the math game is played. The user will obtain two sets of finger coverings 10: one for each hand 12. Referring to FIG. 1 as an example, the user will place the finger coverings 10 in numerical order on each hand 12. FIG. 1 shows the Number 6 finger coverings 10 on the user's thumbs; the Number 7 finger coverings 10 on the user's index fingers; the Number 8 finger coverings 10 on the user's middle fingers; the Number 9 finger coverings 10 on the user's ring fingers; and the Number 10 finger coverings 10 on the user's pinkies.

The user will choose which two numbers (or factors) he/she wishes to multiply. In FIG. 1, the user is multiplying the Number 8 with the Number 7. The user will touch a finger covering 10 of one hand 12 bearing a number 8 (shown on the left hand 12) to a finger covering 10 of the other hand 12 bearing a number 7 (shown on the right hand 12). The user may determine a points total by assigning ten points for each touching finger covering 10 and for each finger covering 10 located above them. In this example, starting with the left hand 12, the user will assign ten points for the Number 8/middle finger covering 10 (one of the touching finger coverings 10), the Number 7/index finger covering 10, and the Number 6/thumb finger covering 10. Continuing with the right hand 12, the user will assign ten points for the Number 7/index finger covering 10 (the other of the touching finger coverings 10), and the Number 6/thumb finger covering 10. For these five finger coverings 10, the user will remember or write down that the points total is fifty.

The user may also determine the points total by assigning one point to each of the finger coverings 10 that are touching and all of the finger coverings 10 located above them, adding those points and multiplying that number of points by a factor of 10. In the same example, the number of touching finger coverings 10 would be two (the Number 8/middle finger covering 10 on the left hand and the Number 7/index finger covering 10 on the right hand) and the number of finger coverings 10 located above the touching finger coverings 10 would be three; making a total of five finger coverings 10. Five multiplied by a factor of ten would make the points total fifty; i.e. 5×10=50.

The user will next determine a first sum on one hand 12 by adding the number of finger coverings 10 on that hand 12 that are below the touching finger coverings 10. In this example, starting with the left hand 12, the number of finger coverings 10 below the touching finger coverings 10 is two; the ring finger and the pinky, specifically. Therefore, the user will remember or write down that the first sum is two.

The user will then determine a second sum on the other hand 12 by adding the number of finger coverings 10 on that other hand 12 that are below the touching finger coverings 10. In this example, continuing with the right hand 12, the number of finger coverings 10 below the touching finger coverings 10 is three; the middle finger, the ring finger, and the pinky, specifically. Therefore, the user will remember or write down that the second sum is three.

Next, the user will determine a first product by multiplying the first sum (which is two on the left hand 12) with the second sum of the other hand (which is three on the right hand 12); i.e. 2×3=6.

Finally, the user will find the final product of the first factor and the second factor by adding the points total to the first product. Continuing with the example, the user will add fifty (the points total) to six (the first product); i.e. 50+6=56. Thus, the user has learned that 8×7=56.

While the invention has been particularly shown and described with reference to preferred embodiments thereof, it will be understood by those skilled in the art that the foregoing and other changes in form and details may be made therein without departing from the spirit and scope of the invention. For example, it should be clearly understood, that substantial benefit may still be obtained if the finger coverings 10 were placed on the fingers 14 in descending order; i.e. if the Number 10 finger covering 10 was on the user's thumb; the Number 9 finger covering 10 was on the user's index finger; the Number 8 finger covering 10 was on the user's middle finger; the Number 7 finger covering 10 was on the user's ring finger; and the Number 6 finger covering 10 was on the user's pinky. The remaining steps, however, would need to be adjusted.

For example, the points total would be determined by assigning ten points to each finger covering 10 touching and each finger covering 10 below the touching finger coverings 10; the user will determine the first sum on the left hand 12 by adding the number of finger coverings 10 on the left hand 12 above the touching finger coverings 10 and will determine the second sum on the right hand 12 by adding the number of finger coverings 10 on the right hand 12 above the touching finger coverings 10. The user will then determine the first product by multiplying the first sum with the second sum. And finally, the user will determine the final product of the first factor and the second factor by adding the points total to the first product.

I claim:

1. A math game comprising the steps of:
providing two sets of finger coverings, each set comprising five finger coverings indicating numbers 6, 7, 8, 9, and 10;
placing a first set of finger coverings in numerical order on a first hand of a user and placing a second set of finger coverings in numerical order on a second hand of the user;
touching a finger covering of the first hand to a finger covering of the second hand;
determining a points total by assigning a predetermined amount of points for each touching finger covering and for each finger covering located one of above and below the touching finger coverings;
determining a first sum by adding a number of finger coverings on the first hand located on an opposite side of the touching finger coverings;
determining a second sum by adding a number of finger coverings on the second hand located on the opposite side of the touching finger coverings;
determining a first product by multiplying the first sum with the second sum; and
determining a final product of the numbers appearing on the touching finger coverings by adding the first product to the points total.

2. The math game of claim 1 further comprising the step of placing the finger coverings on the first hand and the second hand in ascending order.

3. The math game of claim 2 wherein the step of placing the finger coverings in ascending order comprises the steps of:
placing a finger covering bearing a number 6 on each thumb;
placing a finger covering bearing a number 7 on each index finger;
placing a finger covering bearing a number 8 on each middle finger;
placing a finger covering bearing a number 9 on each ring finger; and
placing a finger covering bearing a number 10 on each pinky.

4. The math game of claim 2 wherein the step of determining a points total comprises assigning ten points for each touching finger covering and for each finger covering located above the touching finger coverings.

5. The math game of claim 2 wherein the step of determining a points total comprises the steps of:
assigning one point to each of the touching finger coverings and to each of the finger coverings that are located above the touching finger coverings;
adding the points together; and
multiplying the points by a factor of ten.

6. The math game of claim 2 wherein the step of determining a first sum comprises the step of adding the number of finger coverings on the first hand that are located below the touching finger coverings.

7. The math game of claim 2 wherein the step of determining a second sum comprises the step of adding the number of finger coverings on the second hand that are located below the touching finger coverings.

8. The math game of claim 1 further comprising the step of placing the finger coverings on the first hand and the second hand in descending order.

9. The math game of claim 8 wherein the step of placing the finger coverings in descending order comprises the steps of:
placing a finger covering bearing a number 10 on each thumb;
placing a finger covering bearing a number 9 on each index finger;
placing a finger covering bearing a number 8 on each middle finger;
placing a finger covering bearing a number 7 on each ring finger; and
placing a finger covering bearing a number 6 on each pinky.

10. The math game of claim 8 wherein the step of determining a points total comprises assigning ten points for each touching finger covering and for each finger covering located below the touching finger coverings.

11. The math game of claim 8 wherein the step of determining a points total comprises the steps of:
assigning one point to each of the touching finger coverings and to each of the finger coverings that are located below the touching finger coverings;
adding the points together; and
multiplying the points by a factor of ten.

12. The math game of claim 8 wherein the step of determining a first sum comprises the step of adding the number of finger coverings on the first hand that are located above the touching finger coverings.

13. The math game of claim 8 wherein the step of determining a second sum comprises the step of adding the number of finger coverings on the second hand that are located above the touching finger coverings.

14. A math game comprising the steps of:
providing two sets of finger coverings, each set comprising five finger coverings individually numbered 6, 7, 8, 9, and 10;
placing a first set of finger coverings in ascending order on a first hand of a user and placing a second set of finger coverings in ascending order on a second hand of the user;
selecting a first factor to multiply with a second factor wherein the first factor and second factor are each one of 6, 7, 8, 9, and 10;
touching a finger covering of the first hand that indicates the first factor to a finger covering of the second hand that indicates the second factor;
determining a points total by assigning a predetermined amount of points to each of the touching finger coverings and to each of the finger coverings located above the touching finger coverings;
determining a first sum by adding a number of finger coverings on the first hand that are located below the touching finger coverings;
determining a second sum by adding a number of finger coverings on the second hand that are located below the touching finger coverings;
determining a first product by multiplying the first sum with the second sum; and
determining a final product of the first factor and the second factor by adding the first product to the points total.

15. The math game of claim 14 wherein the step of placing the finger coverings in ascending order on the first hand and the second hand of the user comprises the steps of:
placing a finger covering bearing a number 6 on each thumb;
placing a finger covering bearing a number 7 on each index finger;
placing a finger covering bearing a number 8 on each middle finger;
placing a finger covering bearing a number 9 on each ring finger; and
placing a finger covering bearing a number 10 on each pinky.

16. The math game of claim 14 wherein the step of determining a points total comprises assigning ten points for each touching finger covering and for each finger covering located above the touching finger coverings.

17. The math game of claim 14 wherein the step of determining a points total comprises the steps of:
assigning one point to each of the touching finger coverings and to each of the finger coverings that are located above the touching finger coverings;
adding the points together; and
multiplying the points by a factor of ten.

18. A math game comprising the steps of:
providing two sets of finger coverings, each set comprising five finger coverings individually numbered 6, 7, 8, 9, and 10;
placing a first set of finger coverings in descending order on a first hand of a user and placing a second set of finger coverings in descending order on a second hand of the user;
selecting a first factor to multiply with a second factor wherein the first factor and second factor are each one of 6, 7, 8, 9, and 10;
touching a finger covering of the first hand that indicates the first factor to a finger covering of the second hand that indicates the second factor;
determining a points total by assigning a predetermined amount of points to each of the touching finger coverings and to each of the finger coverings located below the touching finger coverings;
determining a first sum by adding a number of finger coverings on the first hand that are located above the touching finger coverings;
determining a second sum by adding a number of finger coverings on the second hand that are located above the touching finger coverings;
determining a first product by multiplying the first sum with the second sum; and
determining a final product of the first factor and the second factor by adding the first product to the points total.

19. The math game of claim 18 wherein the step of placing the finger coverings in descending order on the first hand and the second hand of the user comprises the steps of:
placing a finger covering bearing a number 10 on each thumb;
placing a finger covering bearing a number 9 on each index finger;
placing a finger covering bearing a number 8 on each middle finger;
placing a finger covering bearing a number 7 on each ring finger; and
placing a finger covering bearing a number 6 on each pinky.

20. The math game of claim 18 wherein the step of determining a points total comprises assigning ten points for each touching finger covering and for each finger covering located below the touching finger coverings.

21. The math game of claim 18 wherein the step of determining a points total comprises the steps of:
assigning one point to each of the touching finger coverings and to each of the finger coverings that are located below the touching finger coverings;
adding the points together; and
multiplying the points by a factor of ten.
